(19) United States
(12) Patent Application Publication
(10) Pub. No.: US 2026/0219372 A1
(43) Pub. Date: Jul. 30, 2026

(54) HIGH PRECISION FAST SCANNING FMCW LIDAR

(71) Applicant: Aeva, Inc., Mountain View, CA (US)

(72) Inventors: Behsan Behzadi, Sunnyvale, CA (US); Huiyuan Liu, San Jose, CA (US); Shirish Ashok Altekar, Palo Alto, CA (US); Mina Rezk, Haymarket, VA (US)

(21) Appl. No.: 19/037,838

(22) Filed: Jan. 27, 2025

(51) Int. Cl. G01S 7/4912; G01S 7/481

(52) U.S. Cl. CPC G01S 7/4912; G01S 7/4815; G01S 7/4817

(57) ABSTRACT

A method of operating a light detection and ranging (LIDAR) system is provided that includes emitting a first laser beam at a first wavelength and a second laser beam at a second wavelength at a scanner, wherein a difference between the first wavelength and the second wavelength is less than a threshold wavelength. The method includes obtaining a first return signal and a second return signal based on the first laser beam and the second laser beam respectively reflecting off of a target. The method includes performing at least one Fast Fourier Transformation (FFT) based on the first return signal and the second return signal to obtain at least one FFT spectrum. The method includes determining a range of a target based on the at least one FFT spectrum.

### TECHNICAL FIELD

The present disclosure relates generally to a high precision fast scanning light detection and ranging (LIDAR) system.

### BACKGROUND

Frequency-Modulated Continuous-Wave (FMCW) LiDAR systems include several possible phase impairments such as range noise and differential Doppler. Additionally, target properties and optical beam properties can cause varying phase impairments, such as speckle. For example, in any coherent LiDAR system, the returning signal from a surface exhibiting diffuse scattering is susceptible to the influence of speckle, an interference pattern occurring in the far-field as a result of multiple scattering centers on a diffuse reflector.

### SUMMARY

The present disclosure includes, without limitation, the following example implementations.

Some example implementations provide a method of operating a light detection and ranging (LIDAR) system including emitting a first laser beam at a first wavelength and a second laser beam at a second wavelength at a scanner, wherein a difference between the first wavelength and the second wavelength is less than a threshold wavelength; obtaining a first return signal and a second return signal based on the first laser beam and the second laser beam respectively reflecting off of a target; performing at least one Fast Fourier Transformation (FFT) based on the first return signal and the second return signal to obtain at least one FFT spectrum; and determining a range of a target based on the at least one FFT spectrum.

In some embodiments, performing the at least one FFT based on the first return signal and the second return signal to obtain the at least one FFT spectrum comprises performing a first FFT on the first return signal to obtain a first FFT spectrum and a second FFT on the second return signal to obtain a second FFT spectrum.

In some embodiments, the method further includes selecting a first peak in the first FFT spectrum and a second peak in the second FFT spectrum, and wherein determining the range of the target based on the at least one FFT spectrum comprises determining the range of the target based on the first peak and the second peak.

In some embodiments, the method further includes performing at least one of a convolution operation or a cross correlation operation on the first FFT spectrum and the second FFT spectrum, wherein determining the range of the target comprises determining the range of the target based on a result of the at least one of the convolution operation or the cross correlation operation.

In some embodiments, the first peak in the first FFT spectrum is symmetric with respect to the second peak in the second FFT spectrum, and wherein range noise is symmetrically spread across the first peak and the second peak.

In some embodiments, the method further includes multiplying the first return signal and the second return signal to obtain a symmetric signal, wherein performing the at least one FFT based on the first return signal and the second return signal to obtain the at least one FFT spectrum comprises performing an FFT on the symmetric signal to obtain an FFT spectrum; and selecting a peak in the FFT spectrum, wherein determining the range of the target comprises determining the range of the target based on the peak.

In some embodiments, the method further includes tuning at least one of the first wavelength or the second wavelength based on cross coupling between a first path associated with the first laser beam and a second path associated with the second laser beam.

In some embodiments, the first laser beam comprises a down chirp and the second laser beam comprises an up chirp.

In some embodiments, the first laser beam comprises a first down chirp and the second laser beam comprises a second down chirp; or the first laser beam comprises a first up chirp and the second laser beam comprises a second up chirp.

In some embodiments, the first laser beam comprises a down chirp sawtooth and the second laser beam comprises an up chirp sawtooth.

In some embodiments, the threshold wavelength comprises 5 nanometers.

In some embodiments, emitting the first laser beam at the first wavelength and the second laser beam at the second wavelength at the scanner comprises emitting the first laser beam at the first wavelength and the second laser beam at the second wavelength at a scanning mirror as the scanning mirror is rotating.

In some embodiments, the first laser beam and the second laser beam are co-aligned on the mirror and the target.

Another example implementation provides a light detection and ranging (LIDAR) system including a first optical source to emit a first laser beam at a first wavelength; a second optical source to emit a second laser beam at a second wavelength, wherein a difference between the first wavelength and the second wavelength is less than a threshold wavelength; a scanner to: receive the emitted first laser beam and the emitted second laser beam; direct the emitted first laser beam and the emitted second laser beam at a target; and obtain a first return signal and a second return signal based on the first laser beam and the second laser beam respectively reflecting off of the target; and a signal processor to: perform at least one Fast Fourier Transformation (FFT) based on the first return signal and the second return signal to obtain at least one FFT spectrum; and determine a range of the target based on the at least one FFT spectrum.

In some embodiments, to perform the at least one FFT based on the first return signal and the second return signal to obtain the at least one FFT spectrum, the signal processor is to perform a first FFT on the first return signal to obtain a first FFT spectrum and a second FFT on the second return signal to obtain a second FFT spectrum.

In some embodiments, the signal processor is further to: select a first peak in the first FFT spectrum and a second peak in the second FFT spectrum, and wherein to determine the range of the target based on the at least one FFT spectrum, the signal processor is to determine the range of the target based on the first peak and the second peak.

In some embodiments, the signal processor is further to: perform at least one of a convolution operation or a cross correlation operation on the first FFT spectrum and the second FFT spectrum, wherein to determine the range of the target, the signal processor is to determine the range of the target based on a result of the at least one of the convolution operation or the cross correlation operation.

In some embodiments, the first peak in the first FFT spectrum is symmetric with respect to the second peak in the second FFT spectrum, and wherein range noise is symmetrically spread across the first peak and the second peak.

In some embodiments, the signal processor is further to: multiply the first return signal and the second return signal to obtain a symmetric signal, wherein to perform the at least one FFT based on the first return signal and the second return signal to obtain the at least one FFT spectrum, the signal processor is to perform an FFT on the symmetric signal to obtain an FFT spectrum; and select a peak in the FFT spectrum, wherein to determine the range of the target, the signal processor is to determine the range of the target based on the peak.

In some embodiments, at least one of the first optical source or the second optical source is configured to tune at least one of the first wavelength or the second wavelength based on cross coupling between a first path associated with the first laser beam and a second path associated with the second laser beam.

In some embodiments, the first laser beam comprises a down chirp and the second laser beam comprises an up chirp.

In some embodiments, the first laser beam comprises a first down chirp and the second laser beam comprises a second down chirp; or the first laser beam comprises a first up chirp and the second laser beam comprises a second up chirp.

In some embodiments, the first laser beam comprises a down chirp sawtooth and the second laser beam comprises an up chirp sawtooth.

In some embodiments, the threshold wavelength comprises 5 nanometers.

In some embodiments, the scanner comprises a scanning mirror configured to rotate to direct the emitted first laser beam and the emitted second laser beam at the target.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects, and advantages will become apparent from the following detailed description taken in conjunction with the accompanying figures which illustrate, by way of example, the principles of some described example implementations.

### BRIEF DESCRIPTION OF THE FIGURES

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 is a block diagram illustrating an example LIDAR system according to embodiments of the present disclosure.

FIG. 2 is a time-frequency diagram illustrating an example of FMCW LIDAR waveforms according to embodiments of the present disclosure.

FIG. 3 is a diagram that illustrates example aspects of differential Doppler impact on range precision according to embodiments of the present disclosure.

FIG. 4 is a diagram that illustrates example aspects of differential Doppler impact on range precision according to embodiments of the present disclosure.

FIG. 5A is a diagram that illustrates an example of a wavelength difference between counter chirp lasers and a conjugate of the counter chirp lasers according to embodiments of the present disclosure.

FIG. 5B is a diagram that illustrates an example of a wavelength difference between counter chirp lasers and a conjugate of the counter chirp lasers according to embodiments of the present disclosure.

FIG. 5C is a diagram that illustrates an example of a wavelength difference between counter chirp lasers and a conjugate of the counter chirp lasers according to embodiments of the present disclosure.

FIG. 5D is a diagram that illustrates an example of a wavelength difference between counter chirp lasers and a conjugate of the counter chirp lasers according to embodiments of the present disclosure.

FIG. 5E is a diagram that illustrates an example of a wavelength difference between counter chirp lasers and a conjugate of the counter chirp lasers according to embodiments of the present disclosure.

FIG. 5F is a diagram that illustrates an example of a wavelength difference between counter chirp lasers and a conjugate of the counter chirp lasers according to embodiments of the present disclosure.

FIG. 6 is a diagram that illustrates an example of digital signal processing (DSP) according to embodiments of the present disclosure.

FIG. 7 is a diagram that illustrates an example of DSP according to embodiments of the present disclosure.

FIG. 8 is a diagram that illustrates an example of DSP according to embodiments of the present disclosure.

FIG. 9 is a diagram that illustrates an example of an optical circuit according to embodiments of the present disclosure.

FIG. 10 is a diagram that illustrates an example of a plot of range precision versus mirror speed according to embodiments of the present disclosure.

FIG. 11 is a diagram that illustrates examples of counter chirp and point selection according to embodiments of the present disclosure.

FIG. 12 is a flow diagram illustrating a method of high precession fast scanning in a LIDAR system according to embodiments of the disclosure.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

The described LIDAR systems herein may be implemented in any sensing market, such as, but not limited to, transportation, manufacturing, metrology, medical, virtual reality, augmented reality, and security systems. According to some embodiments, the described LIDAR system may be implemented as part of a front-end of frequency modulated continuous-wave (FMCW) device that assists with spatial awareness for automated driver assist systems, or self-driving vehicles.

Differential Doppler (i.e., a differential Doppler effect) may refer to a difference in a Doppler shift observed from different parts of a rotating object (e.g., a rotating mirror). A range precision of a scanning FMCW LIDAR may refer to a degree of repeatability in distance measurements, that is, how consistently a LIDAR sensor can measure the same target multiple times under similar conditions. Range precision of a scanning FMCW may determine an accuracy of a subsequently generated three-dimensional (3D) point cloud, which may be used for applications such as autonomous vehicle operation. Range precision of a scanning FMCW LIDAR may be affected by a differential Doppler of an optical beam. For example, the range precision of the scanning FMCW LIDAR may depend on a beam size of a scanning mirror (or other scanners) and a scan speed of the scanning mirror. For some applications, it may be desirable to keep range precision relatively low while scanning relatively fast in order to acquire higher angular resolution.

With more particularity, for a scanning FMCW LIDAR that uses a reflective/refractive materials, a beam may be moved inside a scene in order to capture a relatively large field-of-view (FOV). To achieve a relatively large FOV, the beam may be steered faster in order to capture the larger FOV in a relatively short amount of time (i.e., to obtain a higher frame rate). When the beam is steered slower (i.e., when an angular velocity associated with the beam is relatively low) in a scene, the beam may be associated with a relatively low range precision (i.e., relatively low range noise). However, as the beam is steered faster (i.e., when an angular velocity associated with beam is relatively high) in the scene, the beam may be associated with relatively high range precision (i.e., relatively high range noise). In an example, when an angular velocity associated with the beam is zero, a range precision of a LIDAR system that transmits the beam may be approximately 1 micrometer. When the angular velocity associated with the beam increases to a particular level, the range precision of the LIDAR system may be approximately 1 millimeter. As such, the range precision when the angular velocity increases to the particular level may become one-thousand times worse than the range precision of the LIDAR system when the angular velocity associated with the beam is zero.

Various technologies pertaining to improving range precision in a scanning FMCW LIDAR system are described herein, that is, various technologies pertaining to reducing range noise in a scanning FMCW LIDAR system by reducing or eliminating an impact of a differential Doppler effect are described herein. To achieve the reduction or elimination of the impact of the differential Doppler effect, the present disclosure describes (1) utilizing two lasers that emit laser beams that are relatively close (e.g., within 5 nanometers) in wavelength to one another and (2) utilizing signal processing techniques to reduce or eliminate differential Doppler broadening. Differential Doppler broadening may refer to broadening of a spectral line caused by varying Doppler shifts experienced by different parts of a moving object, resulting in a wider range of observed frequencies within an emitted or absorbed spectral line. Stated different, differential Doppler broadening may refer to an effect of a Doppler shift across a range of velocities within a system, leading to a broadened spectral feature.

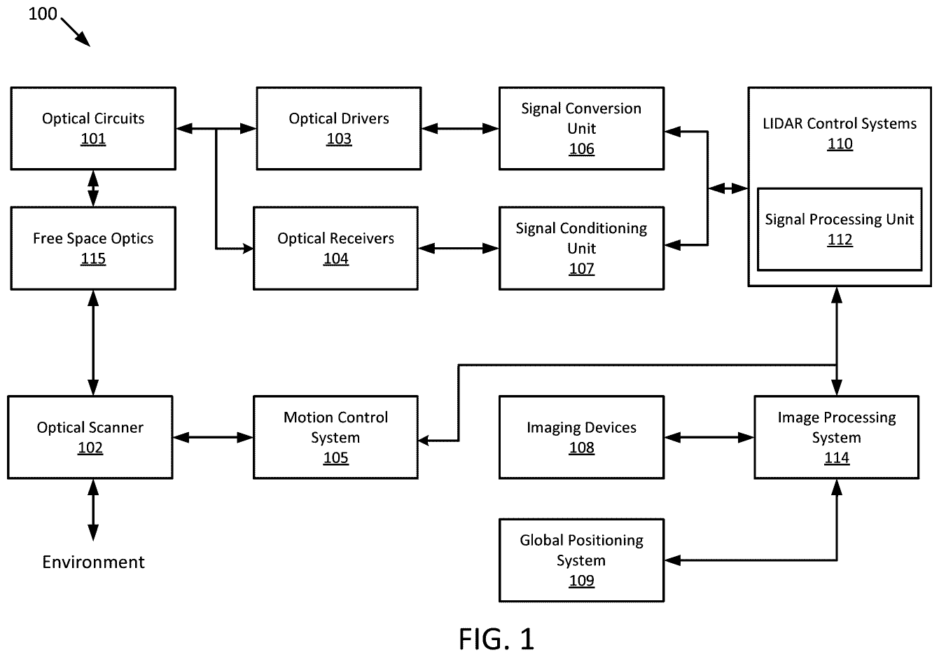

FIG. 1 illustrates a LIDAR system 100 according to example implementations of the present disclosure. The LIDAR system 100 includes one or more of each of a number of components, but may include fewer or additional components than shown in FIG. 1. According to some embodiments, one or more of the components described herein with respect to LIDAR system 100 can be implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles.

In some examples, the LIDAR system 100 includes an optical scanner 102 that includes one or more scanning mirrors that are rotatable along an axis (e.g., a slow-moving-axis) that is orthogonal or substantially orthogonal to the fast-moving-axis of the diffractive element to steer optical signals to scan a target environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coating window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control systems 110 may include a signal processing unit 112 such as a digital signal processor (DSP). The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several of the optical drivers 103 and the signal conversion units 106 may be provided to drive multiple optical sources.

The LIDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and the LIDAR control systems 110. The LIDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, the light may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using analog to digital converters (ADCs). The digital signals are then sent to the LIDAR control systems 110. A signal processing unit 112 may then receive the digital signals and interpret the digital signals. In some embodiments, the signal processing unit 112 also receives position data from the motion control system 105 and galvanometers (not shown), as well as image data from the image processing system 114. The signal processing unit 112 can then generate a three-dimensional (3D) point cloud with information about range and velocity of points in the environment as the optical scanner 102 scans additional points. The signal processing unit 112 can also overlay 3D point cloud data with the image data to determine velocity and distance of objects in the surrounding area. The system also processes the satellite-based navigation location data to provide a precise global location.

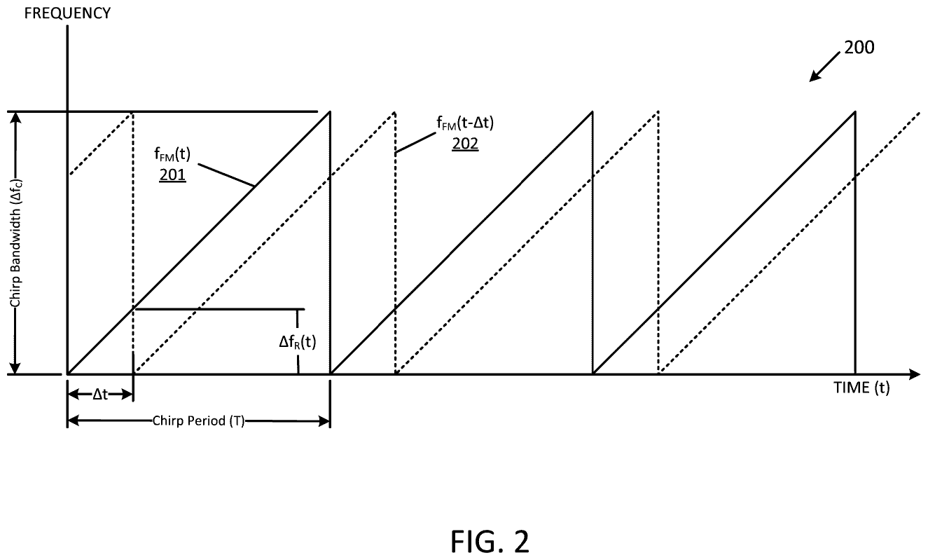

FIG. 2 is a time-frequency diagram 200 of an FMCW scanning signal that can be used by a LIDAR system, such as the LIDAR system 100, to scan a target environment according to some embodiments. In one example, a scanning waveform 201, labeled as f_{FM}(t), is a sawtooth waveform (sawtooth “chirp”) with a chirp bandwidth Δf_{C} and a chirp period T_{C}. The slope of the sawtooth is given as k=(Δf_{C}/T_{C}). FIG. 2 also depicts a target return signal 202 according to some embodiments. The target return signal 202, labeled as f_{FM}(t−Δt), is a time-delayed version of a scanning signal (i.e., the scanning waveform 201), where Δt is the round trip time to and from a target illuminated by the scanning signal (i.e., the scanning waveform 201). The round trip time is given as Δt=2R/v, where R is the target range and v is the velocity of the optical beam, which is the speed of light c. The target range, R, can therefore be calculated as R=c (Δt/2). When the target return signal 202 is optically mixed with the scanning signal, a range-dependent difference frequency (“beat frequency”) Δf_{R}(t) is generated. The beat frequency Δf_{R}(t) is linearly related to the time delay Δt by the slope of the sawtooth k. That is, Δf_{R}(t)=kΔt. Since the target range R is proportional to Δt, the target range R can be calculated as R=(c/2)(Δf_{R}(t)/k). That is, the range R is linearly related to the beat frequency Δf_{R}(t). The beat frequency Δf_{R}(t) can be generated, for example, as an analog signal in the optical receivers 104 of the LIDAR system 100. The beat frequency can then be digitized by an analog-to-digital converter (ADC), for example, in a signal conditioning unit such as the signal conditioning unit 107 in the LIDAR system 100. The digitized beat frequency signal can then be digitally processed, for example, in a signal processing unit, such as the signal processing unit 112 in the LIDAR system 100. It should be noted that the target return signal 202 will, in general, also includes a frequency offset (Doppler shift) if the target has a velocity relative to the LIDAR system 100. The Doppler shift can be determined separately, and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (Δf_{Rmax}) is 500 megahertz. This limit in turn determines the maximum range of the system as Rₘₐₓ=(c/2)(Δf_{Rmax}/k) which can be adjusted by changing the chirp slope k. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner.

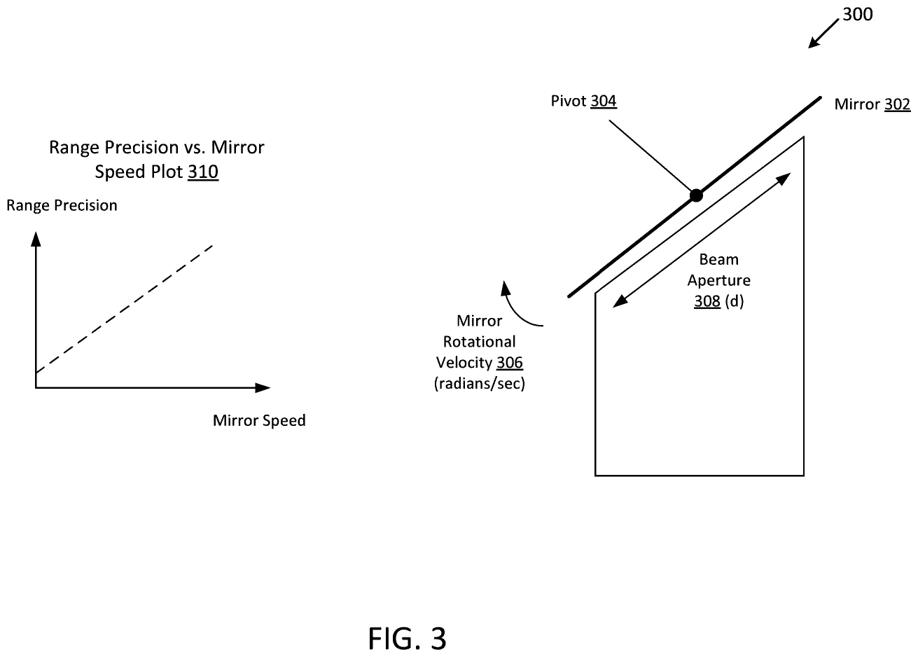

FIG. 3 is a diagram 300 that illustrates example aspects of differential Doppler impact on range precision according to embodiments of the present disclosure. The diagram 300 depicts a mirror 302 that is rotatable about a pivot 304. The mirror 302 and the pivot 304 may be included in the LIDAR system 100 (e.g., in the optical scanner 102). In an example, the LIDAR system 100 may rotate the mirror 302 via the pivot 304 at a mirror rotational velocity 306 which may be measured in radians per second. The mirror rotational velocity 306 may be designated as “w”. The mirror 302 may have a beam aperture 308. A beam aperture may refer to a size of an opening that controls an amount of light a LIDAR system (e.g., the LIDAR system 100) can gather. The beam aperture 308 may be designed as “d.” The LIDAR system 100 may transmit a laser beam towards the mirror 302. The laser beam may have a wavelength which may be designated as “A.” A differential Doppler (DD) may be calculated according to equation (I) below.

$$DD = \frac{4 ω d}{λ} \qquad ( I )$$

An induced range error (i.e., a range precision) may be calculated according to equation (II) below.

$$Induced Range Error = \frac{DD}{Tuning rate} \qquad ( II )$$

In equation (II), the tuning rate may refer to a speed at which a LIDAR system (e.g., the LIDAR system 100) can change a wavelength and/or a frequency of a laser beam, that is, the tuning rate may refer to how quickly the LIDAR system can “tune” to a different frequency within an operating range of the LIDAR system. A tuning rate may be measured in gigahertz per microsecond.

The diagram 300 depicts a range precision vs. mirror speed graph 310 which reflects an effect of increasing a mirror speed (i.e., increasing w in equation (I)) on range precision (i.e., the induced range error in equation (II)). As w increases (i.e., as the mirror rotational velocity 306) increases, DD increases, and hence the induced range error (i.e., range precision increases), that is, range noise increases. As will be described in greater detail below, the present disclosure provides for various techniques to decrease range noise due to DD.

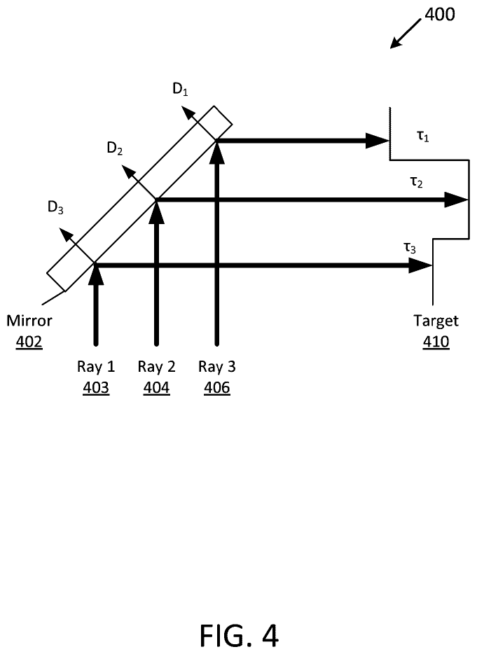

FIG. 4 is a diagram 400 that illustrates example aspects of differential Doppler impact on range precision according to embodiments of the present disclosure. A beam may be split into N rays (N is a positive integer) that each have a separate Doppler frequency shift and a speckle delay, that is, each ray may have a separate (Dᵢ, τᵢ), where Dᵢ refers to Doppler frequency shift and τᵢ refers to a speckle delay. In some aspects described herein, the LIDAR system 100 may transmit a first laser beam (which may alternatively be referred to as “Laser A”) and a second laser beam (which may alternatively be referred to as “Laser B”) according to equations (III) and (IV) below, respectively.

$$Laser A = {\sum }_{i} cos \{ 2 π [ 2 {ατ}_{i} t - {D}_{Ai} t + ( {f}_{A} {τ}_{i} - α {τ}_{i}^{2} ) ] \} \qquad ( III )$$

$$Laser B = {\sum }_{i} cos \{ 2 π [ 2 {ατ}_{i} t - {D}_{Bi} t + ( {f}_{B} {τ}_{i} + α T {τ}_{i} + α {τ}_{i}^{2} ) ] \} \qquad ( IV )$$

In equations (III) and (IV), “a” refers to a chirp rate of a laser. A chirp rate may refer to a rate at which a frequency of a laser changes over time. In equations (III) and (IV), “2ατᵢt” may refer to a center frequency of a laser. When the wavelengths of laser A and laser B are relatively close to one another (e.g., within 5 nanometers of one another), waveforms associated with laser A and laser B become close in shape in time.

In an example, the LIDAR system 100 may transmit a laser beam that is split into a first ray 403, a second ray 404, and a third ray 406. The first ray 403, the second ray 404, and the third ray 406 may reflect off of a mirror 402 (e.g., the mirror 302) at different points on the mirror 402 towards different points on a target 410. The first ray 403, the second ray 404, and the third ray 406 may each be associated with a respective Doppler frequency shift (designed as D₁, D₂, and D₃ in FIG. 4). The target 410 may vary in roughness, that is, the target 410 may have an uneven or irregular surface. As such, the first ray 403, the second ray 404, and the third ray 406 may each be associated with a respective speckle delay (designated as τ₁, τ₂, and τ₃ in FIG. 4).

When a laser beam (i.e., laser light), such as laser A or laser B above, is shined on a target (e.g., the target 410), the laser beam may be treated as a superposition of several rays (e.g., a superposition of the first ray 403, the second ray 404, and the third ray 406). Each ray (e.g., the first ray 403, the second ray 404, and the third ray 406) may experience a different mirror Doppler speed, which may broaden a Fast Fourier Transformation (FFT) peak proportional to a mirror speed and a size of a beam on the mirror. When two laser beams (e.g., laser A and laser B above) are co-aligned on a mirror (e.g., the mirror 402) and a target (e.g., the target 410), and the two laser beams are relatively close in frequency, the two laser beams may both experience the same mirror Doppler effect and the same speckle (target roughness). Mirror Doppler effect may refer to a Doppler effect that occurs when a plane-polarized light wave reflects off of a moving mirror and the frequency of the plane-polarized light wave changes due to motion of the moving mirror. When the two laser beams are counter chirping (i.e., when a first laser beam and a second laser beam are emitted from counter chirped lasers), a spectrum of the FFT due to Doppler broadening becomes symmetric around peaks. Counter chirping may refer to symmetrically opposite chirped laser beams. As such, range noise due to Doppler spread may be symmetrically spread over two laser peaks corresponding to laser A and laser B, and hence range noise may be reduced in estimation of a broadened peak.

In some aspects, high resolution FFT peak picking is utilized to find a symmetric peak for laser A and laser B. In some other aspects, two time domain signals may be multiplied to generate a symmetric signal which may reduce or cancel out Doppler broadening. In some other aspects, a time domain signal for laser A may be multiplied with a conjugate of a time domain signal for laser B (or a time domain signal for laser B may be multiplied with a conjugate of a time domain signal for laser A) to generate the symmetric signal which may reduce or cancel out Doppler broadening.

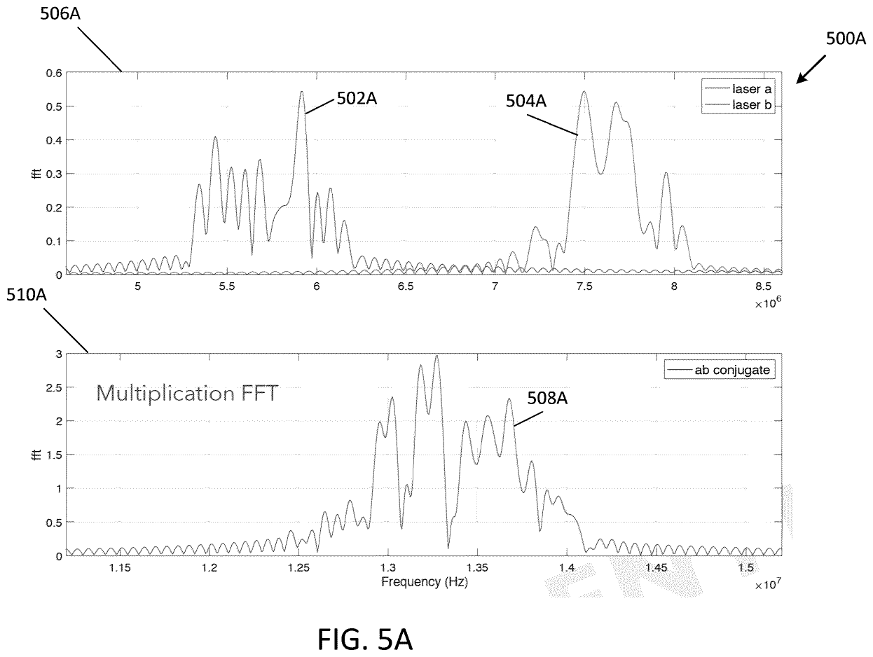

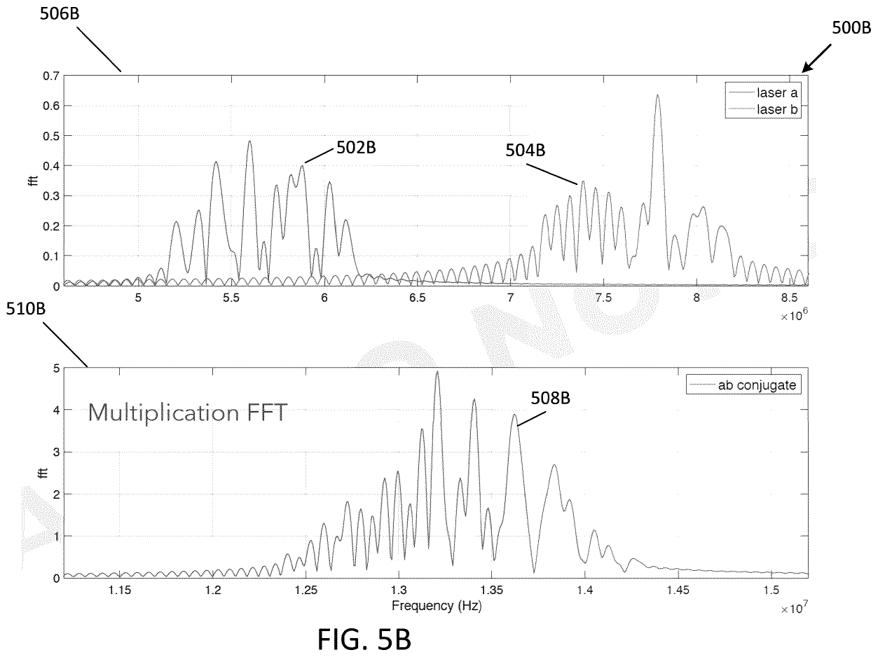

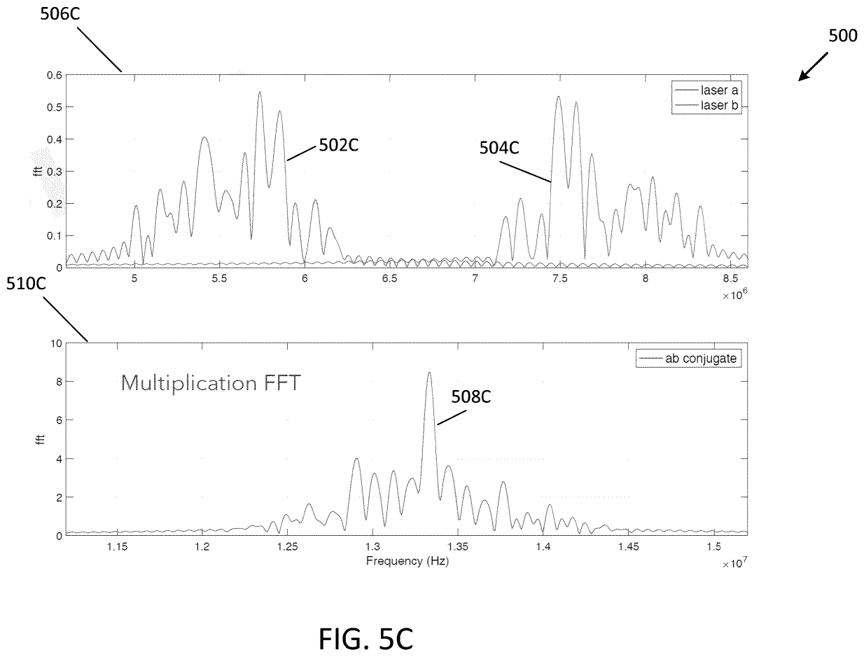

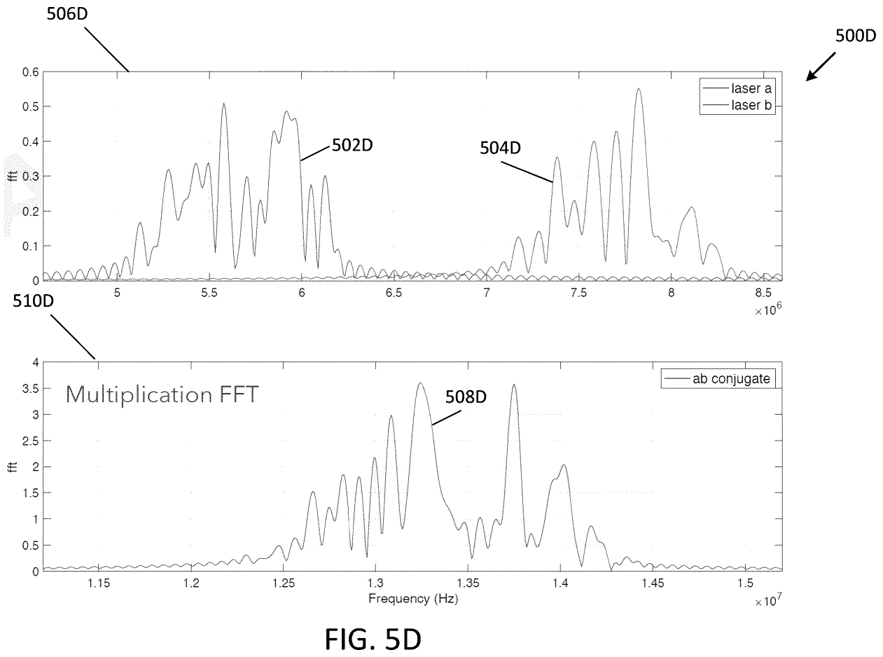

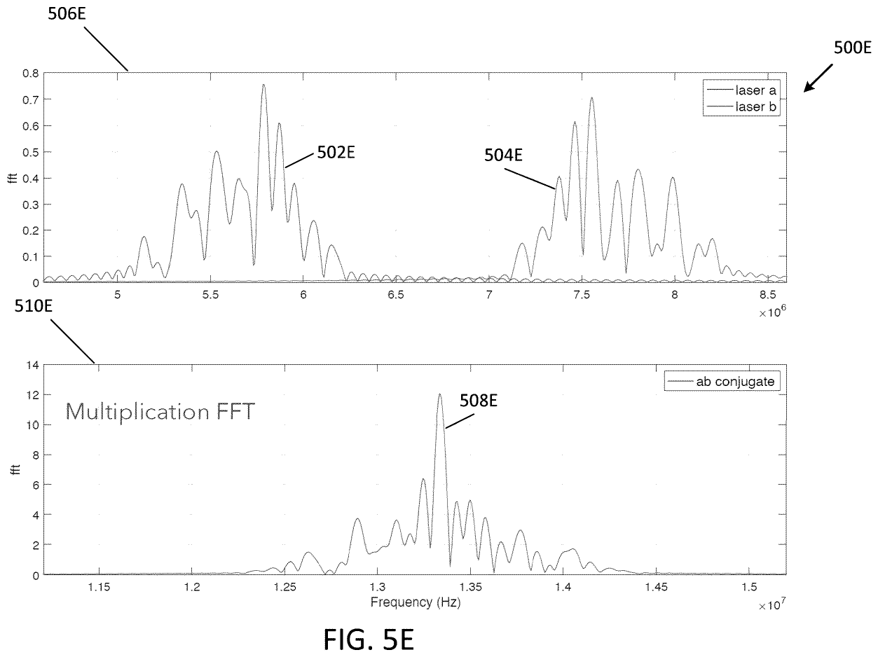

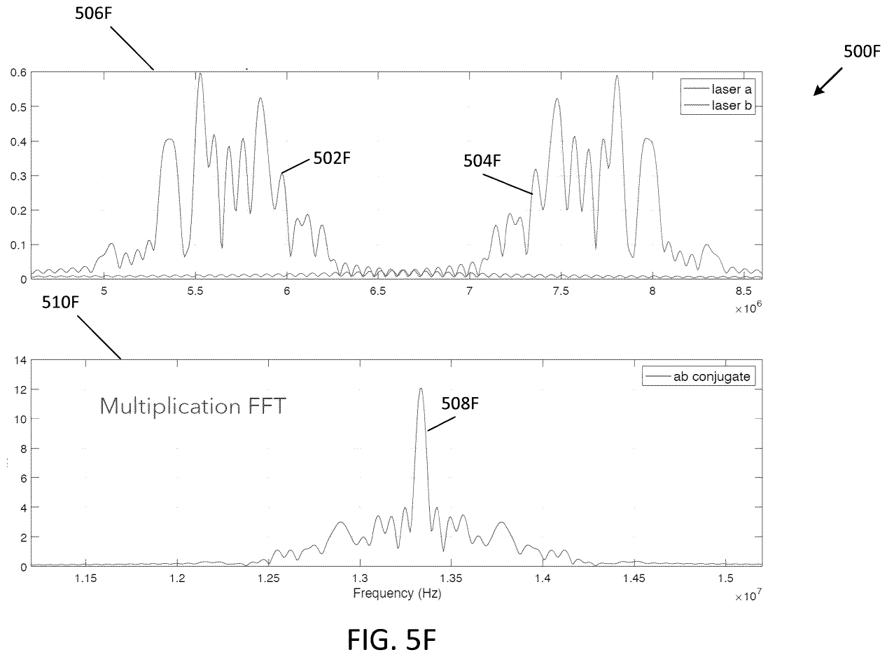

FIG. 5A is a diagram 500A that illustrates an example of a wavelength difference between counter chirp lasers and a conjugate of the counter chirp lasers according to embodiments of the present disclosure. In the example in the diagram 500A, a difference in wavelength between laser A 502A and laser B 504A is relatively large and a speckle thickness standard deviation is relatively large (i.e., a relatively large target roughness). The LIDAR system 100 may perform an FFT on respective return signals (i.e., time domain signals) associated with laser A 502A and laser B 504A to obtain respective FFT spectrums associated with laser A 502A and laser B 504A, which are illustrated in a first plot 506A in FIG. 5A. The first plot 506A depicts FFT vs. frequency. As shown in the first plot 506A, the respective FFT spectrums are somewhat, but not entirely symmetric due to the relatively large wavelength difference and the relatively large target roughness.

The LIDAR system 100 may also multiply the respective return signals associated with laser A 502A and laser B 504A to obtain a multiplied signal. The LIDAR system 100 may perform an FFT on the multiplied signal to obtain a conjugate 508A (i.e., an FFT spectrum) which is depicted in a second plot 510A in FIG. 5A. The second plot 510A also depicts FFT vs. frequency. The conjugate 508A is somewhat, but not entirely symmetric due to the relatively large wavelength difference and the relatively large target roughness.

FIG. 5B is a diagram 500B that illustrates an example of a wavelength difference between counter chirp lasers and a conjugate of the counter chirp lasers according to embodiments of the present disclosure. In the example in the diagram 500B, a difference in wavelength between laser A 502B and laser B 504B is relatively medium (compared to the difference in wavelength illustrated in FIG. 5A and FIG. 5C) and a speckle thickness standard deviation is relatively large (i.e., a relatively large target roughness). The LIDAR system 100 may perform an FFT on respective return signals (i.e., time domain signals) associated with laser A 502B and laser B 504B to obtain respective FFT spectrums associated with laser A 502B and laser B 504B, which are illustrated in a first plot 506B in FIG. 5B. The first plot 506B depicts FFT vs. frequency. As shown in the first plot 506B, the respective FFT spectrums are more symmetric compared to the FFT spectrums in FIG. 5A due to the relatively medium wavelength difference and the relatively large target roughness.

The LIDAR system 100 may also multiply the respective return signals associated with laser A 502B and laser B 504B to obtain a multiplied signal. The LIDAR system 100 may perform an FFT on the multiplied signal to obtain a conjugate 508B (i.e., an FFT spectrum) which is depicted in a second plot 510B in FIG. 5B. The second plot 510B also depicts FFT vs. frequency. The conjugate 508B is more symmetric compared to the conjugate 508A in FIG. 5A due to the relatively medium wavelength difference and the relatively large target roughness.

FIG. 5C is a diagram 500C that illustrates an example of a wavelength difference between counter chirp lasers and a conjugate of the counter chirp lasers according to embodiments of the present disclosure. In the example in the diagram 500C, a difference in wavelength between laser A 502C and laser B 504C is relatively small and a speckle thickness standard deviation is relatively large (i.e., a relatively large target roughness). The LIDAR system 100 may perform an FFT on respective return signals (i.e., time domain signals) associated with laser A 502C and laser B 504C to obtain respective FFT spectrums associated with laser A 502C and laser B 504C, which are illustrated in a first plot 506C in FIG. 5C. The first plot 506C depicts FFT vs. frequency. As shown in the first plot 506C, the respective FFT spectrums are more symmetric compared to the FFT spectrums in FIG. 5B due to the relatively small wavelength difference and the relatively large target roughness.

The LIDAR system 100 may also multiply the respective return signals associated with laser A 502C and laser B 504C to obtain a multiplied signal. The LIDAR system 100 may perform an FFT on the multiplied signal to obtain a conjugate 508C (i.e., an FFT spectrum) which is depicted in a second plot 510C in FIG. 5C. The second plot 510C also depicts FFT vs. frequency. The conjugate 508C is more symmetric compared to the conjugate 508B in FIG. 5B due to the relatively small wavelength difference and the relatively large target roughness.

FIG. 5D is a diagram 500D that illustrates an example of a wavelength difference between counter chirp lasers and a conjugate of the counter chirp lasers according to embodiments of the present disclosure. In the example in the diagram 500D, a difference in wavelength between laser A 502D and laser B 504D is relatively large and a speckle thickness standard deviation is relatively small (i.e., a relatively small target roughness). The LIDAR system 100 may perform an FFT on respective return signals (i.e., time domain signals) associated with laser A 502D and laser B 504D to obtain respective FFT spectrums associated with laser A 502D and laser B 504D, which are illustrated in a first plot 506D in FIG. 5D. The first plot 506D depicts FFT vs. frequency. As shown in the first plot 506D, the respective FFT spectrums are somewhat, but not entirely symmetric due to the relatively large wavelength difference and the relatively small target roughness.

The LIDAR system 100 may also multiply the respective return signals associated with laser A 502D and laser B 504D to obtain a multiplied signal. The LIDAR system 100 may perform an FFT on the multiplied signal to obtain a conjugate 508D (i.e., an FFT spectrum) which is depicted in a second plot 510D in FIG. 5D. The second plot 510D also depicts FFT vs. frequency. The conjugate 508D is somewhat, but not entirely symmetric due to the relatively large wavelength difference and the relatively small target roughness.

FIG. 5E is a diagram 500E that illustrates an example of a wavelength difference between counter chirp lasers and a conjugate of the counter chirp lasers according to embodiments of the present disclosure. In the example in the diagram 500E, a difference in wavelength between laser A 502E and laser B 504E is relatively medium (compared to the difference in wavelength illustrated in FIG. 5D and FIG. 5F) and a speckle thickness standard deviation is relatively small (i.e., a relatively small target roughness). The LIDAR system 100 may perform an FFT on respective return signals (i.e., time domain signals) associated with laser A 502E and laser B 504E to obtain respective FFT spectrums associated with laser A 502E and laser B 504E, which are illustrated in a first plot 506E in FIG. 5E. The first plot 506E depicts FFT vs. frequency. As shown in the first plot 506E, the respective FFT spectrums are more symmetric compared to the FFT spectrums in FIG. 5D due to the relatively medium wavelength difference and the relatively small target roughness.

The LIDAR system 100 may also multiply the respective return signals associated with laser A 502E and laser B 504E to obtain a multiplied signal. The LIDAR system 100 may perform an FFT on the multiplied signal to obtain a conjugate 508E (i.e., an FFT spectrum) which is depicted in a second plot 510E in FIG. 5E. The second plot 510E also depicts FFT vs. frequency. The conjugate 508E is more symmetric compared to the conjugate 508D in FIG. 5D due to the relatively medium wavelength difference and the relatively small target roughness.

FIG. 5F is a diagram 500F that illustrates an example of a wavelength difference between counter chirp lasers and a conjugate of the counter chirp lasers according to embodiments of the present disclosure. In the example in the diagram 500F, a difference in wavelength between laser A 502F and laser B 504F is relatively small and a speckle thickness standard deviation is relatively small (i.e., a relatively small target roughness). The LIDAR system 100 may perform an FFT on respective return signals (i.e., time domain signals) associated with laser A 502F and laser B 504F to obtain respective FFT spectrums associated with laser A 502F and laser B 504F, which are illustrated in a first plot 506F in FIG. 5F. The first plot 506F depicts FFT vs. frequency. As shown in the first plot 506F, the respective FFT spectrums are more symmetric compared to the FFT spectrums in FIG. 5E due to the relatively small wavelength difference and the relatively small target roughness.

The LIDAR system 100 may also multiply the respective return signals associated with laser A 502F and laser B 504F to obtain a multiplied signal. The LIDAR system 100 may perform an FFT on the multiplied signal to obtain a conjugate 508F (i.e., an FFT spectrum) which is depicted in a second plot 510F in FIG. 5F. The second plot 510F also depicts FFT vs. frequency. The conjugate 508F is more symmetric compared to the conjugate 508E in FIG. 5E due to the relatively small wavelength difference and the relatively small target roughness.

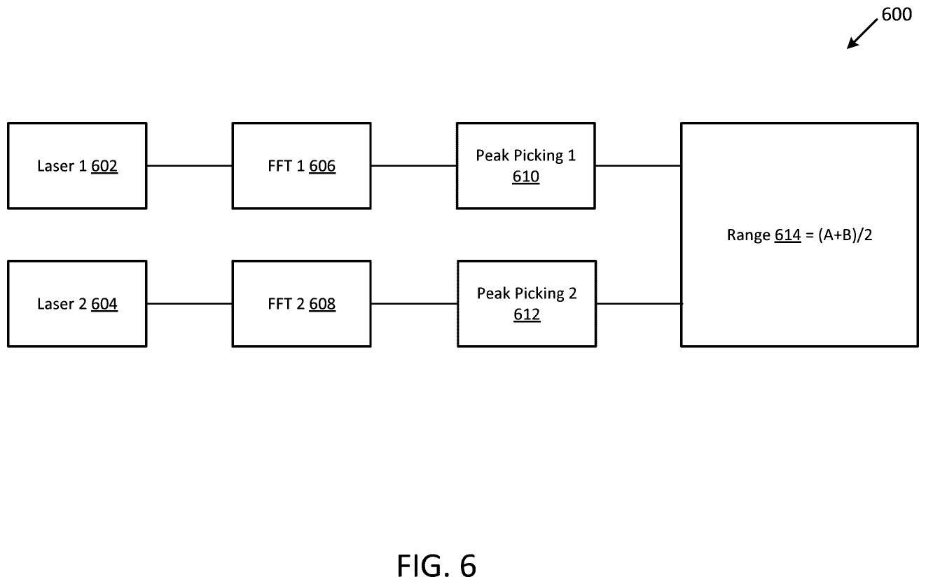

FIG. 6 is a diagram 600 that illustrates an example of digital signal processing (DSP) according to embodiments of the present disclosure. The DSP depicted in FIG. 6 may correspond to the first plot 506A, the first plot 506B, the first plot 506C, the first plot 506D, the first plot 506E, and/or the first plot 506F. In the embodiment in FIG. 6, a first laser 602 (i.e., laser A) transmits a first laser beam and a second laser 604 (i.e., laser B) transmits a second laser beam. The first laser 602 and the second laser 604 may be included in the LIDAR system 100. The first laser beam has a first wavelength and the second laser beam has a second wavelength. A difference between the first wavelength and the second wavelength may be less than a threshold wavelength (e.g., 5 nanometers). The first laser beam and the second laser beam may reflect off of a mirror (e.g., the mirror 402) onto a target (e.g., the target 410). The first laser beam and the second laser beam may be co-aligned on the mirror and the target. The LIDAR system 100 may obtain a first return signal (i.e., a first time domain signal) and a second return signal (i.e., a second time domain signal) based on the first laser beam and the second laser beam reflecting off of the target. The LIDAR system 100 may perform a first FFT 606 on the first return signal to obtain a first FFT spectrum. The LIDAR system 100 may perform a second FFT 608 on the second return signal to obtain a second FFT spectrum. The LIDAR system 100 may perform first peak picking 610 on the first FFT spectrum to obtain a first peak. For instance, the LIDAR system 100 may select a highest peak in the first FFT spectrum. The LIDAR system 100 may perform second peak picking 612 on the second FFT spectrum to obtain a second peak. For instance, the LIDAR system 100 may select a highest peak in the second FFT spectrum. The LIDAR system 100 may compute a range 614 of the target based on the first peak and the second peak. For example, the LIDAR system 100 may compute the range 614 as a sum of a magnitude of the first peak and a magnitude of the second peak divided by 2 (i.e., (A+B)/2). An effecting of broadening Doppler may be reduced or cancelled in the range 614.

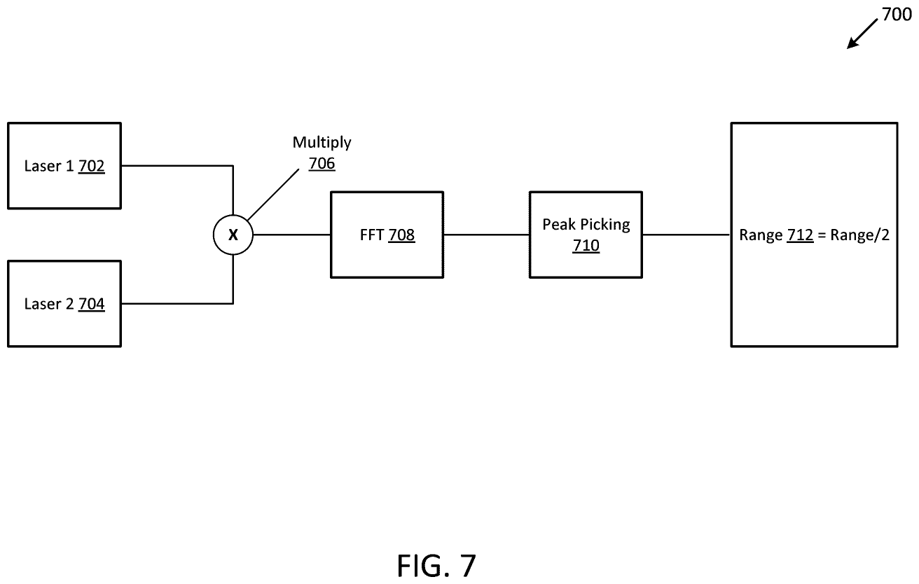

FIG. 7 is a diagram 700 that illustrates an example of DSP according to embodiments of the present disclosure. The DSP depicted in FIG. 7 may correspond to the second plot 510A, the second plot 510B, the second plot 510C, the second plot 510D, the second plot 510E, and/or the second plot 510F. In the embodiment in FIG. 7, a first laser 702 (i.e., laser A) transmits a first laser beam and a second laser 704 (i.e., laser B) transmits a second laser beam. The first laser 702 and the second laser 704 may be included in the LIDAR system 100. The first laser beam has a first wavelength and the second laser beam has a second wavelength. A difference between the first wavelength and the second wavelength may be less than a threshold wavelength (e.g., 5 nanometers). The first laser beam and the second laser beam may reflect off of a mirror (e.g., the mirror 402) onto a target (e.g., the target 410). The first laser beam and the second laser beam may be co-aligned on the mirror and the target. The LIDAR system 100 may obtain a first return signal (i.e., a first time domain signal) and a second return signal (i.e., a second time domain signal) based on the first laser beam and the second laser beam reflecting off of the target.

The LIDAR system 100 may multiply 706 the first return signal and the second return signal to obtain a symmetric signal. The LIDAR system 100 may perform an FFT 708 on the symmetric signal to obtain an FFT spectrum. The LIDAR system 100 may perform peak picking 710 on the FFT spectrum to obtain a peak. For example, the LIDAR system 100 may select a highest peak in the FFT spectrum. The LIDAR system 100 may compute a range 712 of the target based on the peak. For example, the LIDAR system 100 may compute the range 712 of the target as a magnitude of the peak divided by 2. An effecting of broadening Doppler may be reduced or cancelled in the range 712.

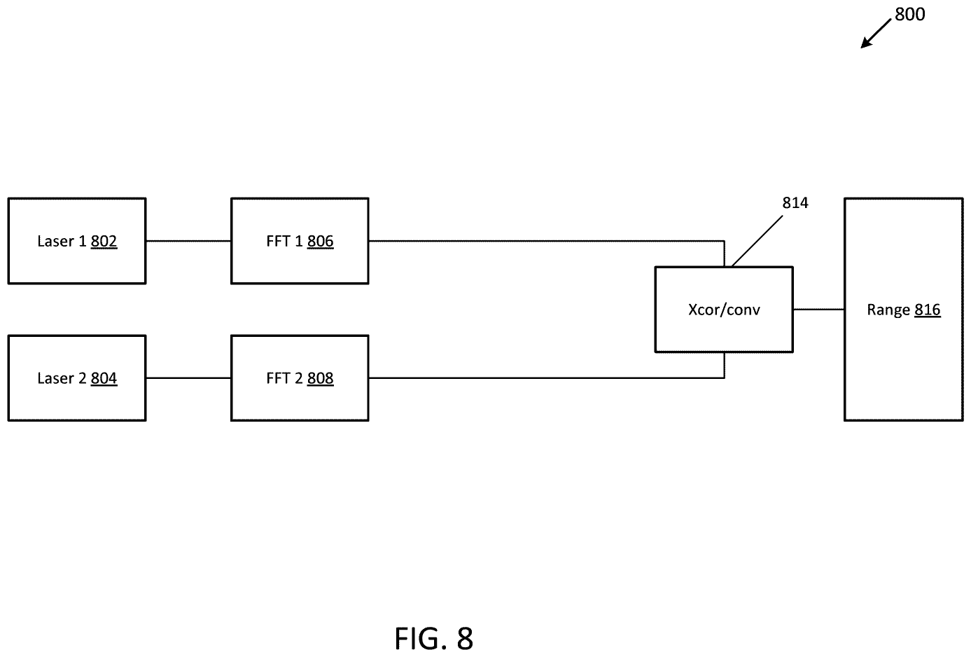

FIG. 8 is a diagram 800 that illustrates an example of DSP according to embodiments of the present disclosure. In the embodiment in FIG. 8, a first laser 802 (i.e., laser A) transmits a first laser beam and a second laser 804 (i.e., laser B) transmits a second laser beam. The first laser 802 and the second laser 804 may be included in the LIDAR system 100. The first laser beam has a first wavelength and the second laser beam has a second wavelength. A difference between the first wavelength and the second wavelength may be less than a threshold wavelength (e.g., 5 nanometers). The first laser beam and the second laser beam may reflect off of a mirror (e.g., the mirror 402) onto a target (e.g., the target 410). The first laser beam and the second laser beam may be co-aligned on the mirror and the target. The LIDAR system 100 may obtain a first return signal (i.e., a first time domain signal) and a second return signal (i.e., a second time domain signal) based on the first laser beam and the second laser beam reflecting off of the target. The LIDAR system 100 may perform a first FFT 806 on the first return signal to obtain a first FFT spectrum. The LIDAR system 100 may perform a second FFT 808 on the second return signal to obtain a second FFT spectrum.

The LIDAR system 100 may perform at least one of a convolution operation or a cross correlation operation 814 on the first FFT spectrum and the second FFT spectrum. The convolution and/or the cross correlation operation 814 may shift the first FFT spectrum and/or the second FFT spectrum to find an optimal overlap between the first FFT spectrum and the second FFT spectrum. The LIDAR system 100 may compute a range 816 of the target based on the at least one of the convolution operation or the cross correlation operation 814. An effect of broadening Doppler may be reduced or cancelled in the range 816.

In some aspects, the LIDAR system 100 may obtain a first FFT spectrum and a second FFT spectrum (e.g., as described above in FIG. 6 and FIG. 8). The LIDAR system may compute a center of mass between the first FFT spectrum and the second FFT spectrum. The LIDAR system 100 may derive a range of a target based on the center of mass.

In some aspects, the LIDAR system 100 may selectively tune a first wavelength of a first laser beam and a second wavelength of a second laser beam based on a degree of cross coupling between a first path associated with the first laser beam and a second path associated with the second laser beam. The LIDAR system may then compute a range of a target as described above in the description of FIG. 6, FIG. 7, and/or FIG. 8.

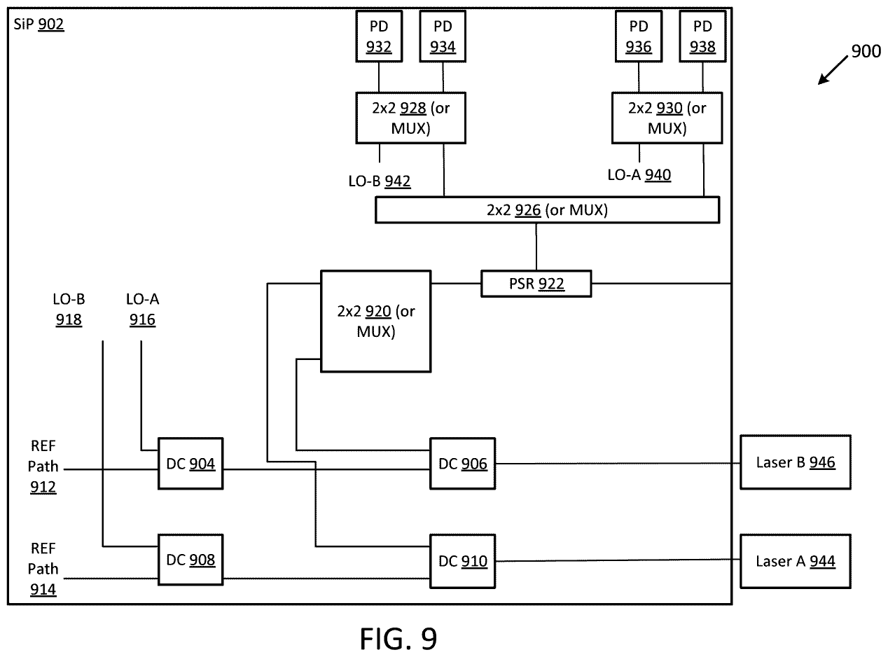

FIG. 9 is a diagram 900 that illustrates an example of an optical circuit according to embodiments of the present disclosure. The optical circuit may be included in the LIDAR system 100 (e.g., as part of the optical circuits 101). The optical circuit may be used generate and transmit a first laser beam of a first wavelength and a second laser beam of a second wavelength, where a difference between the first wavelength and the second wavelength is less than a threshold wavelength (e.g., 5 nanometers). The optical circuit may reduce or eliminate cross talk between the first laser beam and the second laser beam. The optical circuit may facilitate the determination of a range of a target (i.e., a distance between a target and the LIDAR system 100) as described herein.

The optical circuit includes silicon photonics (SiP) 902. The SiP 902 includes directional coupler (DC) 904, DC 906, DC 908, and DC 910. The SiP 902 includes a reference (REF) path 912 and a REF path 914. The SiP 902 includes local oscillator for laser A (LO-A) 916 and a local oscillator for laser B (LO-B) 918. The SiP 902 includes a 2×2 920 (or a multiplexer (MUX)). As used herein, the term “2×2” may refer to a mixer or an optical mixer. The SiP 902 includes a polarization splitter rotator (PSR) 922. The SiP 902 includes a 2×2 926 (or a MUX). The SiP 902 includes a 2×2 928 (or a MUX) and a 2×2 930 (or a MUX). The SiP 902 includes a 2×2 928 (or a MUX) and a 2×2 930 (or a MUX). The SiP 902 includes a photodiode (PD) 932, a PD 934, a PD 936, and a PD 938. The SiP 902 includes a LO-A 940 and a LO-B 942. The SiP 902 is coupled to laser A 944 and laser B 946.

In an example, laser A 944 may transmit light to DC 910. In the example, a first percentage (e.g., 10%) of the light may go to REF path 914 and a second percentage (e.g., 90%) may go to 2×2 920 (or the MUX). A similar process may occur with respect to laser B 946. The 2×2 920 (or the MUX) may divide the combined light from laser A 944 and light from laser B 946 by two. The (divided) light may be then travel through PSR 922. The light may pass out of the SiP 902, reflect off a target, and return through PSR 922. The returned light then passes through 2×2 926, which divides the (returned) light by two. In a first path, a first portion of the (divided and returned) light may pass through 2×2 928 (or a MUX) and is mixed with a signal from LO-B 942 and divided by two. In a second path, a second portion of the (divided and returned) light may pass through 2×2 930 (or a MUX) and is mixed with a signal from LO-A 940 and divided by two. The aforementioned mixing of the first portion of the light with LO-B 942 and the second portion of the light with LO-A 940 may eliminate cross talk between laser A 944 and laser B 946. The output of 2×2 928 may be provided to PD 932 and PD 934 and the output of 2×2 930 may be provided to PD 936 and PD 938, which convert light to electricity.

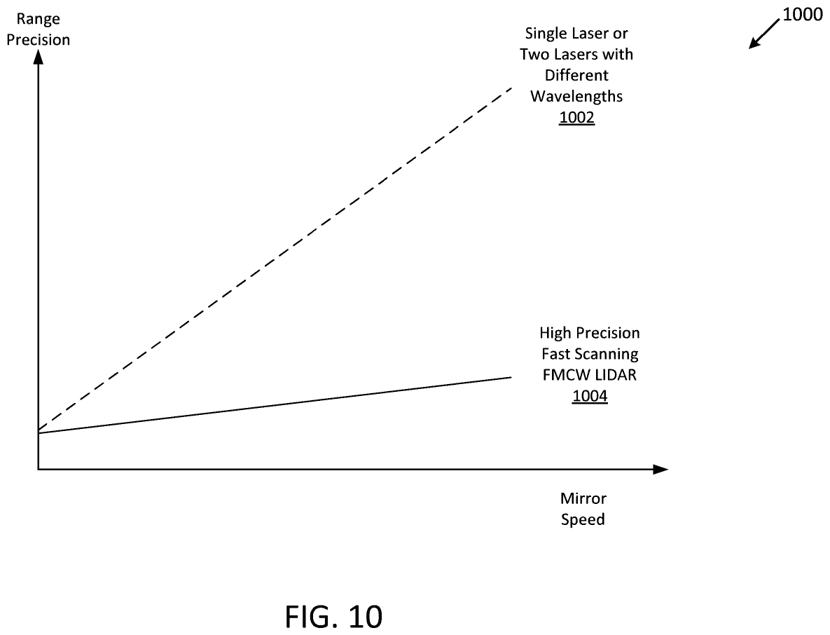

FIG. 10 is a diagram 1000 that illustrates an example of a plot of range precision versus mirror speed according to embodiments of the present disclosure. The diagram 1000 depicts a plot of range precision versus mirror speed for a single laser or two lasers with different wavelengths 1002 (i.e., two lasers with wavelengths having a difference that is greater than a threshold wavelength) and for a high precision fast scanning FMCW LIDAR 1004, such as the high precision fast scanning FMCW LIDAR described herein that utilizes two lasers with wavelengths having a difference that is less than the threshold wavelength. As depicted in the diagram 1000, range precision of the high precision fast scanning FMCW LIDAR 1004 increases at a slower rate than a rate of the single laser or two lasers with different wavelengths 1002. As such, the high precision fast scanning FMCW LIDAR 1004 described herein may be associated with less range noise than the single laser or two lasers with different wavelengths 1002.

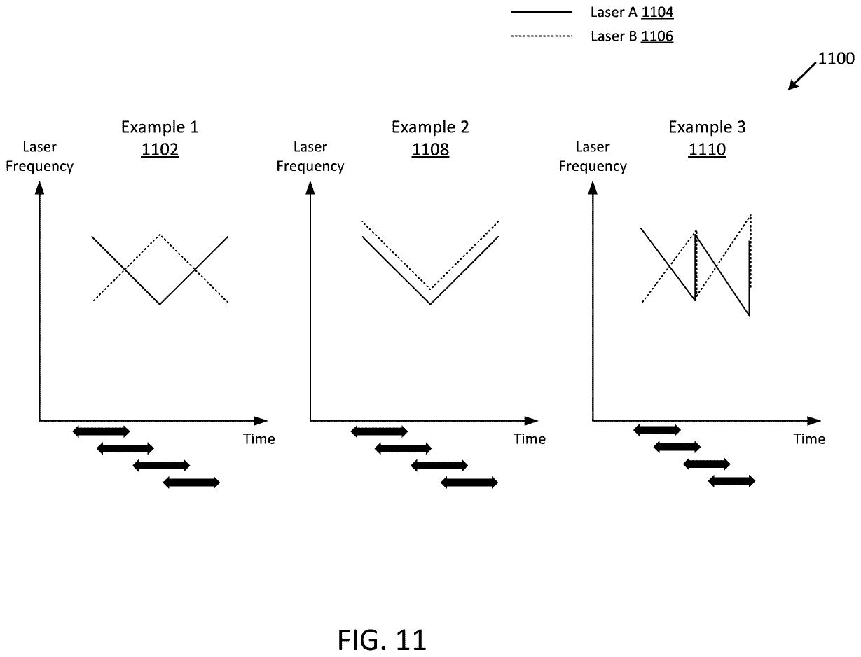

FIG. 11 is a diagram 1100 that illustrates examples of counter chirp and point selection according to embodiments of the present disclosure. In a first example 1102, laser A 1104 emits a down chirp laser beam and laser B 1106 emits an up chirp laser beam. A window for a FFT may be or include sliding overlapping windows on a per point basis or non-overlapping windows. A difference between a wavelength of the down chirp laser beam and a wavelength of the up chirp laser beam may be less than a threshold wavelength (e.g., 5 nanometers).

In a second example 1108, laser A 1104 emits a first down chirp laser beam and laser B 1106 emits a second down chirp laser beam. A window for a FFT may be or include sliding overlapping windows on a per point basis or non-overlapping windows. A difference between a wavelength of the first down chirp laser beam and a wavelength of the second down chirp laser beam may be less than a threshold wavelength (e.g., 5 nanometers).

In a third example 1110, laser A 1104 emits a down chirp sawtooth laser beam and laser B 1106 emits an up chirp sawtooth laser beam. A window for a FFT may be or include sliding overlapping windows on a per point basis or non-overlapping windows. A difference between a wavelength of the down chirp sawtooth laser beam and a wavelength of the up chirp sawtooth laser beam may be less than a threshold wavelength (e.g., 5 nanometers).

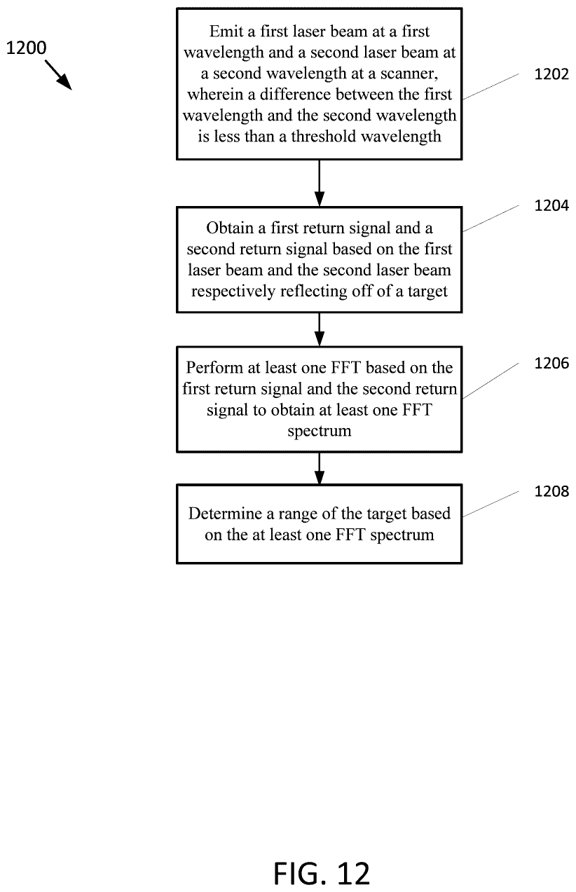

FIG. 12 is a flow diagram illustrating a method 1200 of high precession fast scanning in a LIDAR system, according to embodiments of the disclosure. In embodiments, various portions of method 1200 may be performed by LIDAR system of FIG. 1. With reference to FIG. 12, the method 1200 illustrates example functions used by various embodiments. Although specific function blocks (“blocks”) are disclosed in the method 1200, such blocks are examples. That is, embodiments are well suited to performing various other blocks or variations of the blocks recited in the method 1200. It is appreciated that the blocks in method 1200 may be performed in an order different than presented, and that not all of the blocks in the method 1200 may be performed.

At block 1202, a LIDAR system emits a first laser beam at a first wavelength and a second laser beam at a second wavelength at a scanner (e.g., a scanning mirror), wherein a difference between the first wavelength and the second wavelength is less than a threshold wavelength. For example, the first laser beam may be associated with the first laser 602, the first laser 702, or the first laser 802. For example, the second laser beam may be associated with the second laser 604, the second laser 704, or the second laser 804. In another example, the first laser beam may be laser A and the second laser beam may be laser B as described in FIGS. 5A-5F. In an example, the scanner may be or include the mirror 302 or the mirror 402.

At block 1204, the LIDAR system obtains a first return signal and a second return signal based on the first laser beam and the second laser beam respectively reflecting off of a target.

At block 1206, the LIDAR system performs at least one FFT based on the first return signal and the second return signal to obtain at least one FFT spectrum. In an example, the at least one FFT may include the first FFT 606 and the second FFT 608. In another example, the at least one FFT may include the FFT 708. In another example, the at least one FFT may include the first FFT 806 and the second FFT 808. In an example, the at least one FFT spectrum may be an FFT spectrum illustrated in FIGS. 5A-5F.

At block 1208, the LIDAR system determine a range of the target based on the at least one FFT spectrum. In an example, the range may correspond to the range 614, the range 712, or the range 816.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems. Embodiments of the claimed subject matter include, but are not limited to, various operations described herein. These operations may be performed by hardware components, software, firmware, or a combination thereof.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method of operating a light detection and ranging (LIDAR) system, comprising:
emitting a first laser beam at a first wavelength and a second laser beam at a second wavelength at a scanner, wherein a difference between the first wavelength and the second wavelength is less than a threshold wavelength;
obtaining a first return signal and a second return signal based on the first laser beam and the second laser beam respectively reflecting off of a target;
performing at least one Fast Fourier Transformation (FFT) based on the first return signal and the second return signal to obtain at least one FFT spectrum; and
determining a range of a target based on the at least one FFT spectrum.

2. The method of claim 1, wherein performing the at least one FFT based on the first return signal and the second return signal to obtain the at least one FFT spectrum comprises performing a first FFT on the first return signal to obtain a first FFT spectrum and a second FFT on the second return signal to obtain a second FFT spectrum.

3. The method of claim 2, further comprising:
selecting a first peak in the first FFT spectrum and a second peak in the second FFT spectrum, and wherein determining the range of the target based on the at least one FFT spectrum comprises determining the range of the target based on the first peak and the second peak.

4. The method of claim 2, further comprising:
performing at least one of a convolution operation or a cross correlation operation on the first FFT spectrum and the second FFT spectrum, wherein determining the range of the target comprises determining the range of the target based on a result of the at least one of the convolution operation or the cross correlation operation.

5. The method of claim 3, wherein the first peak in the first FFT spectrum is symmetric with respect to the second peak in the second FFT spectrum, and wherein range noise is symmetrically spread across the first peak and the second peak.

6. The method of claim 1, further comprising:
multiplying the first return signal and the second return signal to obtain a symmetric signal, wherein performing the at least one FFT based on the first return signal and the second return signal to obtain the at least one FFT spectrum comprises performing an FFT on the symmetric signal to obtain an FFT spectrum; and
selecting a peak in the FFT spectrum, wherein determining the range of the target comprises determining the range of the target based on the peak.

7. The method of claim 1, further comprising:
tuning at least one of the first wavelength or the second wavelength based on cross coupling between a first path associated with the first laser beam and a second path associated with the second laser beam.

8. The method of claim 1, wherein the first laser beam comprises a down chirp and the second laser beam comprises an up chirp.

9. The method of claim 1, wherein:
the first laser beam comprises a first down chirp and the second laser beam comprises a second down chirp; or
the first laser beam comprises a first up chirp and the second laser beam comprises a second up chirp.

10. The method of claim 1, wherein the first laser beam comprises a down chirp sawtooth and the second laser beam comprises an up chirp sawtooth.

11. The method of claim 1, wherein the threshold wavelength comprises 5 nanometers.

12. The method of claim 1, wherein emitting the first laser beam at the first wavelength and the second laser beam at the second wavelength at the scanner comprises emitting the first laser beam at the first wavelength and the second laser beam at the second wavelength at a scanning mirror as the scanning mirror is rotating.

13. The method of claim 12, wherein the first laser beam and the second laser beam are co-aligned on the mirror and the target.

14. A light detection and ranging (LIDAR) system, comprising:
a first optical source to emit a first laser beam at a first wavelength;
a second optical source to emit a second laser beam at a second wavelength, wherein a difference between the first wavelength and the second wavelength is less than a threshold wavelength;
a scanner to:
receive the emitted first laser beam and the emitted second laser beam;
direct the emitted first laser beam and the emitted second laser beam at a target; and
obtain a first return signal and a second return signal based on the first laser beam and the second laser beam respectively reflecting off of the target; and
a signal processor to:
perform at least one Fast Fourier Transformation (FFT) based on the first return signal and the second return signal to obtain at least one FFT spectrum; and
determine a range of the target based on the at least one FFT spectrum.

15. The LIDAR system of claim 14, wherein to perform the at least one FFT based on the first return signal and the second return signal to obtain the at least one FFT spectrum, the signal processor is to perform a first FFT on the first return signal to obtain a first FFT spectrum and a second FFT on the second return signal to obtain a second FFT spectrum.

16. The LIDAR system of claim 15, wherein the signal processor is further to:
select a first peak in the first FFT spectrum and a second peak in the second FFT spectrum, and wherein to determine the range of the target based on the at least one FFT spectrum, the signal processor is to determine the range of the target based on the first peak and the second peak.

17. The LIDAR system of claim 15, wherein the signal processor is further to:
perform at least one of a convolution operation or a cross correlation operation on the first FFT spectrum and the second FFT spectrum, wherein to determine the range of the target, the signal processor is to determine the range of the target based on a result of the at least one of the convolution operation or the cross correlation operation.

18. The LIDAR system of claim 14, wherein the signal processor is further to:
multiply the first return signal and the second return signal to obtain a symmetric signal, wherein to perform the at least one FFT based on the first return signal and the second return signal to obtain the at least one FFT spectrum, the signal processor is to perform an FFT on the symmetric signal to obtain an FFT spectrum; and
select a peak in the FFT spectrum, wherein to determine the range of the target, the signal processor is to determine the range of the target based on the peak.

19. The LIDAR system of claim 14, wherein the threshold wavelength comprises 5 nanometers.

20. The LIDAR system of claim 14, wherein the scanner comprises a scanning mirror configured to rotate to direct the emitted first laser beam and the emitted second laser beam at the target.
